(19) United States
(12) Patent Application Publication
(10) Pub. No.: US 2018/0095793 A1
(43) Pub. Date: Apr. 5, 2018

(54) METHODS AND APPARATUS TO SCHEDULE OPERATIONS FOR RESOURCE SHARING IN COMPUTING SYSTEMS

(71) Applicant: Intel Corporation, Santa Clara, CA (US)

(72) Inventors: Vikas Shivappa, Union City, CA (US); Fenghua Yu, Palo Alto, CA (US); Anthony E. Luck, San Jose, CA (US); Ravi V. Shankar, Cupertino, CA (US)

(21) Appl. No.: 15/282,715

(22) Filed: Sep. 30, 2016

(51) Int. Cl. G06F 9/50

(52) U.S. Cl. CPC G06F 9/50

(57) ABSTRACT

Methods and apparatus to schedule operations in computing systems are disclosed. An example method includes determining, by executing an instruction with a processor, that an operation identifier is inactive, the operation identifier assigned to a first operation, the operation identifier utilized by the processor to allocate computing resources of a computing system to the first active operation and in response to a request for assignment of an operation identifier to a second operation: freeing, by executing an instruction with a processor, the operation identifier from the first operation, and assigning, by executing an instruction with a processor, the operation identifier to the second operation.

### TECHNICAL FIELD

This disclosure relates generally to computing resources, and, more particularly, to methods and apparatus to schedule operations for resource sharing in computing systems.

### BACKGROUND

Computing systems that simultaneously execute multiple operations (e.g., threads, tasks, processes, etc.) may provide functionality to manage sharing of computing resources (e.g., cache memory, processor time, physical memory, memory bandwidth, etc.). For example, some computing systems allocate computing resources to operations by assigning an identifier (e.g., a class of service identifier (CLOSId)) to the operation. Each time the operation is scheduled for execution, the CLOSId associated with the operation is identified to the processor or other hardware element servicing the operation (e.g., the CLOSId is stored in a register). For example, every instruction will identify the CLOSId, each reference to a memory location will identify the CLOSId to the processor, etc.

In some such systems, a physical processing unit includes module(s) to manage the allocation of the computing resources according to the identifications. For example, the module(s) may limit the amount of cache that may be allocated to particular operations. By controlling the cache allocation, the module(s) allow the execution environment (e.g., the operation system) to direct that higher priority operations are allocated more of the cache resources.

### BRIEF DESCRIPTION OF THE DRAWINGS

FIG. 1 is a block diagram of an example environment in which an example processor executes an example operating system that includes an example virtual operation identifier manager for managing the assignment of operation identifiers to example operations executing within the example operating system in accordance with the teachings of this disclosure.

FIG. 2 is a block diagram of an example implementation of the example virtual operation identifier manager of FIG. 1.

FIG. 3 is a flow diagram representative of example machine readable instructions that may be executed to assign an operation identifier to an operation and schedule the operation for execution on the example processor of FIG. 1.

FIG. 4 is a flow diagram representative of example machine readable instructions that may be executed to identify an operation identifier(s) that is a candidate for reassignment.

FIG. 5 is a block diagram of an example processor platform capable of executing the instructions of FIG. 3 and/or FIG. 4 to implement the example virtual operation identifier manager of FIG. 1 and/or FIG. 2.

### DETAILED DESCRIPTION

Including resource control functionality (e.g., modules) in association with processing units, motherboards, control boards, etc. of a computing system enables greater control over the allocation of computing resources. Such control is especially important when a computing system (e.g., a server) supports virtualized workloads (e.g., simultaneous operation of large numbers of virtualized workloads) that are competing for access to computing resources. In particular, virtualized workloads with real-time or near-real-time operation demands (e.g., network function virtualization systems, software defined networking systems, etc.) benefit greatly from quality of service controls that, for example, resolve cache contention and ensure that high priority operations have access to computing resources when requested.

Assigning identifiers (e.g., Class of Service Identifiers (CLOSIds) to operations allows the execution environment (e.g., the operating system) to identify operations and/or groups of operations (e.g., tasks, task groups, etc.) to the processing unit to allow the processing unit to allocate computing resources according to the identifications. However, in some implementations, the number of separate identifiers is limited by the hardware space available for the identifications (e.g., where a cache bit mask register is utilized to store an identifier, the size of the register may prevent a limiting factor to the number of separate identifiers that can be allocated). Furthermore, even if the size of the register could be increased, such a modification requires a hardware change.

Methods and apparatus disclosed herein mange and track the allocation of operation identifiers (e.g., CLOSIds) to operations to track the utilization of the operation identifiers and to re-assign the operation identifiers that are determined to be inactive. As used herein, inactive operation identifiers may be assigned to operations that are associated with a process, application, thread, etc. that is active (e.g., that has been started and has not been terminated (e.g., an application or process for which an instance has been started and that instance has not yet been terminated). For example, a record is kept of the allocation of each operation identifier to an operation and each time an operation identifier is utilized by the assigned operation, a timestamp in the record is updated. When a new operation (e.g., an operation that does not yet have an operation identifier) requests an operation identifier, the existing operation identifier that was least recently used (according to the timestamps) is re-assigned to the new operation. Accordingly, the number of operations to which operation identifiers are assigned can increase beyond a limited number of operation identifiers (e.g., a hardware-limited number of operation identifiers) without triggering an error (e.g., an error indicating that all operation identifiers have been assigned when attempting to register a new operation for an operation identifier). In some examples disclosed herein, the processing to determine which operation identifier is the next to be re-assigned (e.g., the current least recently used operation identifier) is performed separately from the operation scheduling to ensure that the overhead associated with the identification of identifier(s) for reassignment does not substantially impact the operation scheduling.

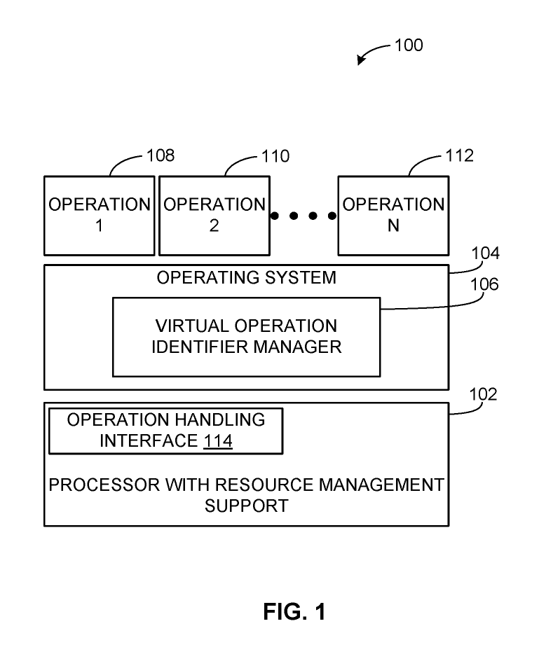

FIG. 1 is a block diagram of an example environment 100 in which an example processor 102 executes an example operating system 104 that includes an example virtual operation identifier manager 106 for managing the assignment of operation identifiers (e.g., class of service identifiers (CLOSIds)) to example operations 108-112 executing within the example operating system 104.

The processor 102 of the illustrated example includes resource management support to manage the allocation of resources to operations. The example processor 102 is an Intel® Xeon® processor. Alternatively, the processor 102 may be any other brand and/or type of processor. As used herein, an operation may be a task, a task group, an instruction, a thread, multiple threads, a process, or any other type of operating unit that may be executed on the example processor 102. According to the illustrated example, the resource management support functionality is integrated in the example processor 102. Alternatively, the resource management support functionality may be provided by a component that is separate from the processor 102 (e.g., a separate processing unit, chip, or other hardware (e.g., installed on a motherboard or other board associated with the processor 102), by a software manager, a firmware manager, etc.).

According to the illustrated example, the processor 102 includes an operating handling interface 114 to receive an operation identifier in conjunction with an operation to be executed on the processor 102. When an operation identifier is provided in association with an operation for execution, the example processor 102 allocates resources to the operation based on the operation identifier. According to the illustrated example, the operation handling interface 114 receives instructions on how to use the operation identifiers for allocating resources. For example, the operation handling interface 114 may receive information about priorities for operation identifiers (e.g., an assignment of operation identifiers to a range of priorities (e.g., high priority, standard priority, low priority), a minimum resource level to dedicate to an operation identifier (e.g., an instruction to allocate a minimum among of cache to a particular operation identifier), an assignment of an operation identifier to particular resources (e.g., an assignment to use a portion of a cache, an assignment to use a particular level of cache, etc.), or any other assignment of rules, limits, etc. for an operation identifier.

While the example processor 102 of FIG. 1 includes the resource management support functionality in the operation handling interface 114, resource management may, alternatively, be handled by another device in a computing system. For example, a motherboard, graphics processing unit, co-processor, etc. may include resource management support and an operating system may interact with that support in accordance with teachings of this disclosure.

While a single processor 102 is illustrated in the environment 100, a computing system may include any number of processors 102. Furthermore, the processor 102 may include multiple logical processing units within a physical processor (e.g., multiple cores) and may include capabilities to execute multiple threads within a single physical or logical processing unit (e.g., may utilize hyper-threading capabilities).

According to the illustrated example, there are a limited number of operation identifiers that can be represented to the example processor 102. For example, the processor 102 may include a register in which the operation identifier is inserted via the operation handling interface 114 and the register may have a fixed bit-length that limits the number of operation identifiers that can be represented. According to the illustrated example, the number of operation identifiers is less than the number of operations that can be simultaneously scheduled on the processor 102 (e.g., the processor 102 with multiple cores can schedule 30 threads but only has sufficient register space to represent 20 operation identifiers). Accordingly, if each operation were to be assigned a separate operation identifier, the system would be a number of operation identifiers short (e.g., 10) and an attempt to schedule the 21^{st} operation identifier would result in an error. While the example processor 102 includes a register for the operation identifier, any other manner of communicating an operation identifier associated with an operation may be utilized. For example, the processor 102 or other component handling operation identifiers may not include a register for the operation identifier and may, instead, receive an instruction identifying the operation, may receive a message identifying the operation, etc. Additionally, even if the processor 102 includes a register, the operation identifier may be communicated in any other manner (e.g., instruction, message, etc.).

According to the illustrated example, the operating system 104 executing on the processor 102 has been instrumented with the example virtual operation identifier manager 106 to manage the assignment of operation identifiers. The virtual operation identifier manager 106 of this example is structured to assign and re-assign the available operation identifiers (e.g., the 20 operation identifiers of the example processor 102).

The operating system 104 of the illustrated example is a Linux operating system for which the kernel has been modified to include the example virtual operation identifier manager 106. Alternatively, any other type of operating system may be utilized (e.g., Microsoft® Windows®, OS X® from Apple®, etc.) and the virtual operation identifier manager 106 may be included in the operating system 104 in any manner (e.g., integration during the development of the operating system 104, added by a plugin to the operating system 104, added by an executing application controlling the operating system (e.g., interfacing with an application program interface (API) of the operating system 104), etc.).

The virtual operation identifier manager 106 of the illustrated example schedules the execution of operations on the example processor 102 and manages the assignment of operation identifiers (e.g., CLOSIds) to those operations to allow control and management of the allocation of computing resources. After assigning an operation identifier to an operation, the example virtual operation identifier manager 106 tracks each use of the operation identifier (and other available operation identifiers assigned to other operations). When all operation identifiers available from the example processor 102 have been assigned, the example virtual operation identifier manager 106 determines a least recently used operation identifier to be reassigned to the next operation that requests an operation identifier. Alternatively, any other algorithm may be utilized for determining the next operation identifier to be assigned (e.g., a least frequently utilized operation identifier or any other algorithm to determine an inactive operation).

The example virtual operation identifier manager 106 periodically updates the identification of the least recently used operation identifier to ensure that the next operation identifier to be used is ready when a request for assignment of a new identifier is received to ensure that scheduling of the operations is not delayed waiting for the virtual operation identifier manager 106. Alternatively, the virtual operation identifier manager 106 may determine the least recently used operation identifier in response to a request for a new operation identifier assignment.

According to the illustrated example, the virtual operation identifier manager 106 includes a use duration threshold that a user may set to control a length of time (e.g., a minimum duration) from a last use of the operation by the current operation before the operation identifier can be freed and assigned to another operation. Additionally or alternatively, the use duration threshold may specify a minimum duration from the initial assignment of the operation identifier to the operation.

The example virtual operation identifier manager 106 additionally includes an option to specify a force operation identifier setting for an operation and/or group of operations. According to the illustrated example, when the force operation identifier setting is enabled for an operation and/or group of operations, the example virtual operation identifier manager 106 will attempt to assign a new operation identifier whenever the operation and/or an operation from the group of operations is to be scheduled for execution and an operation identifier is not currently assigned. When the force operation identifier setting is not enabled, the virtual operation identifier manager 106 of the example of FIG. 1 will utilize a default operation identifier for operations that are not currently assigned an operation identifier at the time they are to be scheduled.

The example operations 108, 110, 112 are processes and/or groups of processes that are executing within the operating system 104. The operations 108, 110, 112 may be tasks, task groups, threads, applications, virtual machines, or any other types of processes and/or groups of processes. For example, the example operation 108 may be an application including several processes that have multiple threads executing within the example operation system 104 on the example processor 102.

In operation of the example environment 100, when the example operation 108 begins execution and a new thread of the operation 108 is to be executed within the example operation system 104, the example virtual operation identifier manager 106 determines if the force operation identifier setting is set for the operation and, if so, determines a least recently used operation identifier (e.g., retrieves an identification of a least recently used operation identifier that has already been determined and stored in a queue) and confirms that the use duration threshold has been met for the identified operation identifier. If the threshold is met, the example virtual operation identifier manager 106 frees the identified operation identifier from the prior operation and assigns the operation identifier to the operation of the operation 108. The example virtual operation identifier manager 106 then schedules the operation for execution on the example processor 102 and updates a timestamp for the assigned operation identifier to record the most recent use of the operation identifier. Accordingly, even if all operation identifiers available from the example processor 102 have previously been assigned to operations, the example virtual operation identifier manager 106 manages the operation identifiers to ensure that a new operation and/or group of operations can be assigned an operation identifier.

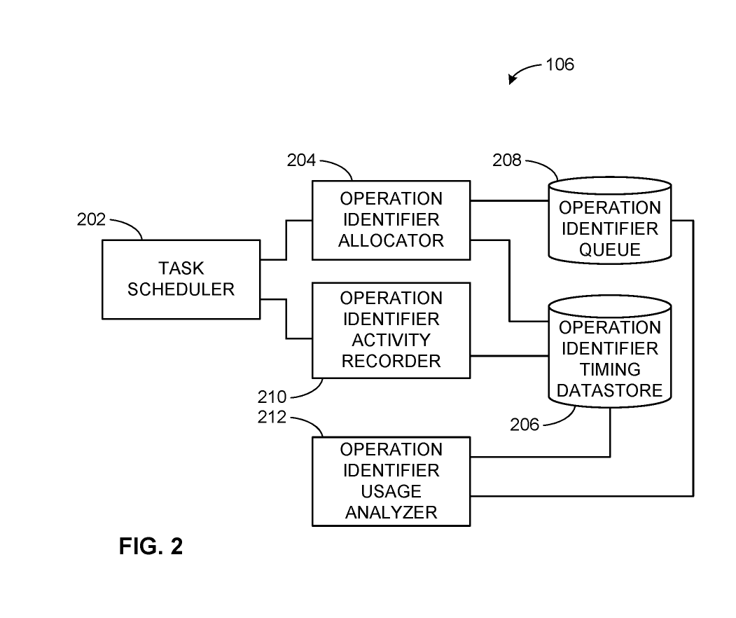

FIG. 2 is a block diagram of an example implementation of the example virtual operation identifier manager 106 of FIG. 1. The example virtual operation identifier manager 106 of FIG. 2 includes an example task scheduler 202, an example operation identifier allocator 204, an example operation identifier timing datastore 206, an example operation identifier queue 208, an example operation identifier activity recorder 210, and an example operation identifier usage analyzer 212.

The example task scheduler 202 of the illustrated example schedules operations for execution on the example processor 102. The example task scheduler 202 further requests and includes operation identifiers assigned by the example operation identifier allocator 204 in the scheduling of the execution of the operations. For example, according to the illustrated example, when an operation is to be scheduled with an operation identifier, the example task scheduler 202 requests and receives an operation identifier from the example operation identifier allocator 204 and stores the operation identifier in a register of the example processor 102 to notify the processor 102 that the operation is to be executed in accordance with the operation identifier. Alternatively, the operation identifier may be provided to the processor 102 in any other manner (e.g., by an interface of the processor 102, by adding the operation identifier to the operation (e.g., appending the operation identifier to the operation), etc.).

The example task scheduler 202 of FIG. 2 is integrated into the kernel of the operating system 104. Alternatively, the task scheduler 202 may be a separate component from the example operating system (e.g., an application executing within the operating system, an application executing outside the operating system, a firmware module associated with a motherboard on which the processor 102 is installed, a module of the processor 102, etc.).

The example operation identifier allocator 204 of the illustrated example receives requests for an operation identifier and returns an operation identifier retrieved from the example operation identifier queue 208. In addition, when the operation identifier allocator 204 assigns an operation identifier, the operation identifier allocator 204 stores an identification of the new association of the operation and the operation identifier in the example operation identifier timing datastore 206. This new association frees the operation identifier from the previously assigned operation. The operation identifier allocator 204 also records a timestamp of the new assignment/use of the operation identifier.

According to the illustrated example, before an operation identifier is reassigned, the operation identifier allocator 204 also determines if a selected candidate meets a use duration threshold. For example, the operation identifier allocator 204 determines if the difference between the current time and the last timestamp recorded for the operation identifier in the example operation identifier timing datastore 206 meets a threshold (e.g., is greater than the duration threshold, is greater than or equal to the duration threshold, etc.). To prevent removal of an operation identifier too frequently, if the duration threshold is not met, the operation identifier allocator 204 does not reassign the operating identifier to the newly requesting operation. Accordingly, the example operation identifier allocator 204 will continue to wait for a candidate operation identifier to be made available that meets the threshold and/or would assign the default operation identifier.

The example operation identifier timing datastore 206 of the illustrated example is a table indexed by operation identifier (e.g., by CLOSId) that stores the association of an operation with the operation identifier. The example operation identifier timing datastore 206 also stores a timestamp for each operation identifier indicating the most recent time when an operation assigned to the operation was scheduled on the processor 102. Utilizing a timestamp integer provides a low overhead option for the example operation identifier allocator 204 and/or the example operation identifier activity recorder 210 to update and track usage of the operation identifier by an increment and/or read of the timestamp integer, respectively. Alternatively, any other type of value may be stored such as, for example, a count of the number of times that an operation has utilized an operation identifier, a timestamp that maintains the time of the original assignment of the operation identifier to the operation, etc.

The example operation identifier timing datastore 206 of FIG. 2 is a table structure stored in a memory. Alternatively, the operation identifier timing datastore 206 may be any other type of data storage such as a database, a file, a list, a queue, a stack, etc.

The example operation identifier queue 208 of FIG. 2 is a queue to store an operation identifier that has been identified as the least active and a candidate for assignment to a new operation. Alternatively, the operation identifier queue 208 may store any number of identified operation identifiers (e.g., a first candidate and a second candidate, a list of all operation identifiers and an order in which they should be selected for reassignment, etc.). While the example operation identifier queue 208 is a queue, any other type of storage may be utilized (e.g., a register, a file, a list, a stack, a database, an environment variable, etc.).

The example operation identifier activity recorder 210 of FIG. 2 monitors the scheduling of operations by the example task scheduler 202 and records activity in the example operation identifier timing datastore 206 when an operation associated with an operation identifier is scheduled. According to the illustrated example, the operation identifier activity recorder 210 updates a timestamp each time an operation identifier is utilized by an operation. Additionally or alternatively, the operation identifier activity recorder 210 may store any other information about the use of the operation identifier (e.g., may update a count of the number of times that an operation identifier is utilized).

The example operation identifier usage analyzer 212 of FIG. 2 periodically analyzes the operation identifier timing information stored in the example operation identifier timing datastore 206 to identify an operation identifier that is a candidate for reassignment and stores the candidate in the example operation identifier queue 208. According to the illustrated example, the operation identifier usage analyzer 212 identifies an inactive operation identifier (e.g., an operation identifier determined to be inactive even though the operation associated with the operation has not yet been terminated) that is a candidate for reassignment by determining the least recently used operation identifier (e.g., the operation identifier that has the oldest assigned timestamp). Alternatively, the operation identifier usage analyzer 212 may utilize any other method for determining a candidate operation identifier or plurality of operation identifiers. For example, the operation identifier usage analyzer 212 may organize the operation identifiers into a list with the least recently used operation identifier at the start of the list, may determine a least frequently used operation identifier, may determine an operation identifier with the oldest timestamp for the initial assignment to an operation, etc.

While an example manner of implementing the example virtual operation identifier manager 106 of FIG. 1 is illustrated in FIG. 2, one or more of the elements, processes and/or devices illustrated in FIG. 2 may be combined, divided, re-arranged, omitted, eliminated and/or implemented in any other way. Further, the example task scheduler 202, the example operation identifier allocator 204, the example operation identifier activity recorder 210, the example operation identifier activity analyzer 212, and/or, more generally, the example virtual operation identifier manager 106 of FIG. 2 may be implemented by hardware, software, firmware and/or any combination of hardware, software and/or firmware. Thus, for example, any of the example task scheduler 202, the example operation identifier allocator 204, the example operation identifier activity recorder 210, the example operation identifier activity analyzer 212, and/or, more generally, the example virtual operation identifier manager 106 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example task scheduler 202, the example operation identifier allocator 204, the example operation identifier activity recorder 210, the example operation identifier activity analyzer 212, and/or, more generally, the example virtual operation identifier manager 106 of FIG. 2 is/are hereby expressly defined to include a tangible computer readable storage device or storage disk such as a memory, a digital versatile disk (DVD), a compact disk (CD), a Blu-ray disk, etc. storing the software and/or firmware. Further still, the example virtual operation identifier 106 of FIG. 1 may include one or more elements, processes and/or devices in addition to, or instead of, those illustrated in FIG. 2, and/or may include more than one of any or all of the illustrated elements, processes and devices.

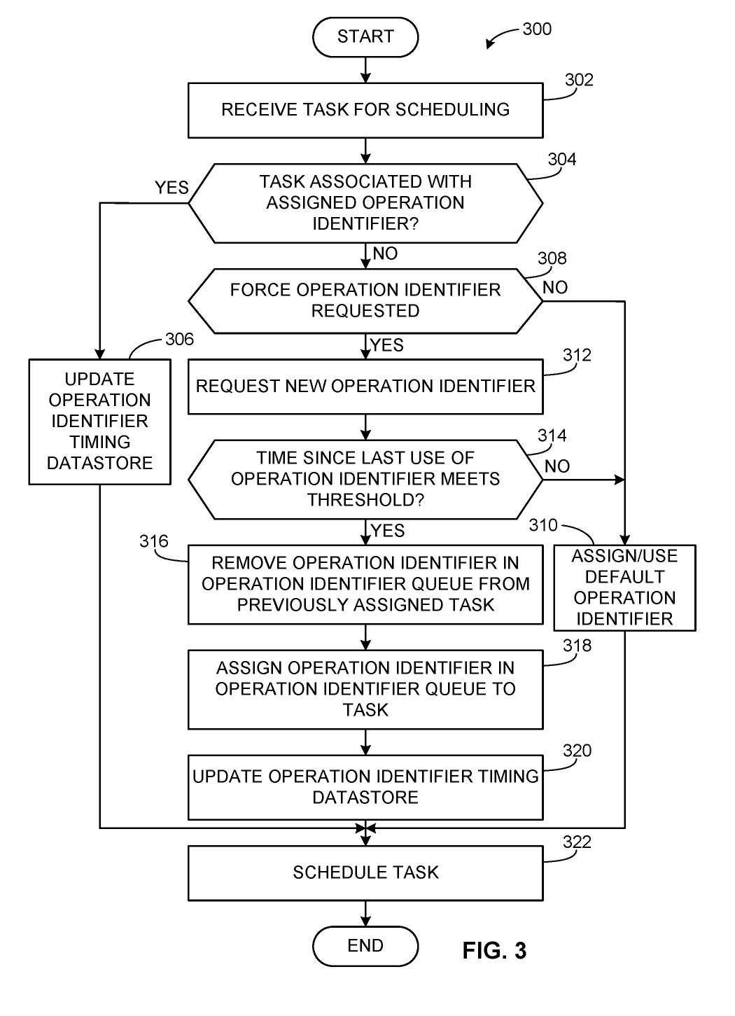

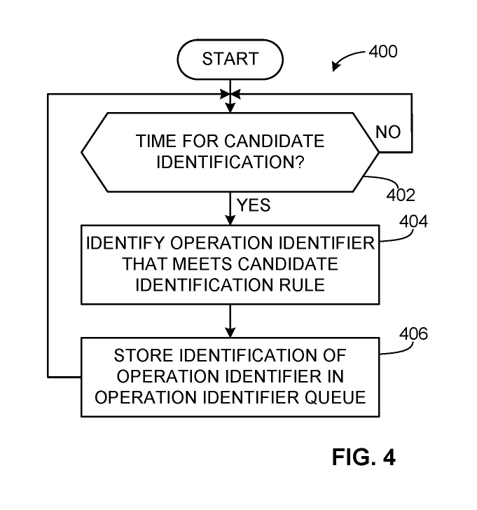

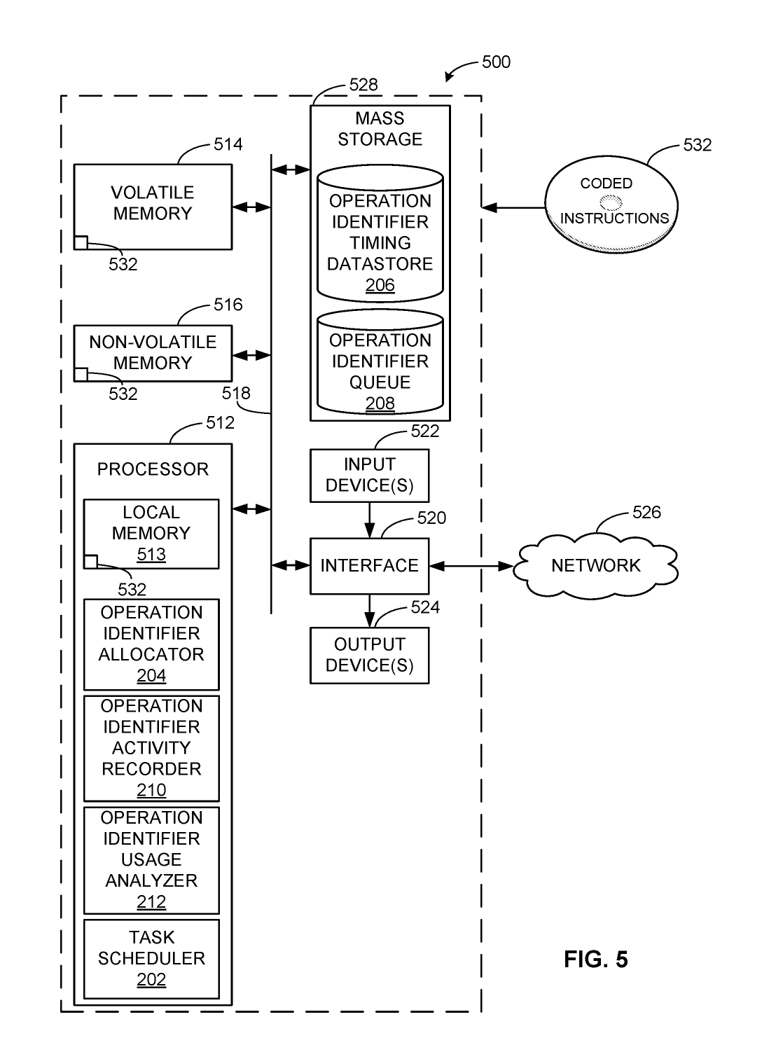

Flowcharts representative of example machine readable instructions for implementing the example virtual operation identifier manager 106 of FIG. 1 and/or FIG. 2 are illustrated in FIG. 3 and FIG. 4. In the examples, the machine readable instructions comprise a program(s) for execution by a processor such as the processor 512 shown in the example processor platform 500 discussed below in connection with FIG. 5. The program may be embodied in software stored on a tangible computer readable storage medium such as a CD-ROM, a floppy disk, a hard drive, a digital versatile disk (DVD), a Blu-ray disk, or a memory associated with the processor 512, but the entire program and/or parts thereof could alternatively be executed by a device other than the processor 512 and/or embodied in firmware or dedicated hardware. Further, although the example program(s) is described with reference to the flowcharts illustrated in FIG. 3 and/or FIG. 4, many other methods of implementing the example virtual operation identifier manager 106 may alternatively be used. For example, the order of execution of the blocks may be changed, and/or some of the blocks described may be changed, eliminated, or combined.

As mentioned above, the example processes of FIG. 3 and/or FIG. 4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIG. 3 and/or FIG. 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 3 is a flow diagram 300 representative of example machine readable instructions that may be executed to assign an operation identifier to a task and schedule the task for execution on the example processor 102 of FIG. 1. The example process 300 of FIG. 3 begins when the example task scheduler 202 receives a task for scheduling on the example processor 102 of FIG. 1 (block 302). For example, the task may be any type of operation (e.g., an instruction, a thread, a process, a request to access cache memory, etc.). The example task scheduler 202 determines if the task is associated with an assigned operation identifier (block 304). When the task is already assigned an operation identifier, the example operation identifier activity recorder 210 updates a timestamp (or other tracking value) in the example operation identifier timing datastore 206) (block 306) and control proceeds to block 322 to schedule the task in the processor 102.

When the example task scheduler 202 determines that the task to be scheduled is not associated with an operation identifier (block 304), the example task scheduler 202 determines if a force operation identifier is requested (block 308). For example, the task may be submitted to the scheduler by the operation system 104 with a flag indicating that a force operation identifier is requested. For example, the force operation identifier flag may be used to indicate that an operation identifier should be assigned to an operation when there is no operation identifier currently assigned to the operation and/or when there are no free operation identifiers (e.g., not operation identifiers of the example processor 102 that are not currently assigned to an operation). When the force operation identifier is not requested, the example task scheduler 202 assigns the default operation identifier to the task and control proceeds to block 322 to schedule the task in the processor 102.

When the force operation identifier is requested (block 308), the example task scheduler 202 requests a new operation identifier from the example operation identifier allocator 204 (block 312). The example operation identifier allocator 204 determines, for an operation identifier identified in the example operation identifier queue 208, if a time since the last use of the operation identifier meets a threshold (block 314). For example, the operation identifier allocator 204 may subtract a current time from a timestamp associated with the operation identifier identified in the operation identifier queue 208 (e.g., a timestamp retrieved from the example operation identifier timing datastore 206) and compare the difference to the threshold. When the difference does not satisfy the threshold (e.g., an insufficient amount of time has passed since the latest use of the operation identifier), the example task scheduler 202 assigns the default operation identifier to the task and control proceeds to block 322 to schedule the task in the processor 102.

When the difference satisfies the threshold (e.g., a sufficient amount of time has passed since the latest use of the operation identifier), the example operation identifier allocator 204 removes (e.g., frees) the operation identifier identified in the example operation identifier queue 208 from the previously assigned task (e.g., task group, operation, etc.) (block 316). The example operation identifier allocator 204 then assigns the operation identifier identified in the example operation identifier queue 208 to the task that has been submitted for scheduling (block 318). For instance, the example operation identifier allocator 204 may, as part of assigning the operation identifier, remove the operation identifier from the operation identifier queue 208 and may record the updated assignment in the example operation identifier timing datastore (e.g., may record an association of the task with the operation identifier, may record a timestamp indicating the time at which the task was assigned the operation identifier, etc.). The example operation identifier activity recorder 210 then updates the operation identifier timing datastore with a timestamp identifying the use of the operation identifier (block 320).

Following block 306, block 310, and/or block 320, the example task scheduler 202 schedules the task for execution on the processor 102 (block 322). According to the illustrated example, the example task scheduler 202 identifies an associated operation identifier (or a default operation identifier) in a register of the processor 102 in associated with the scheduling of the task on the processor 102.

While the illustrated example of FIG. 3 assigns operation identifiers from the example operation identifier queue 208, operation identifiers may, additionally or alternatively, be assigned from a set of operation identifiers that are not currently assigned to any task. For example, the set of operation identifiers available from the processor 102 may not be currently fully utilized (e.g., at least one operation identifier is not currently assigned to any task or task group). Additionally or alternatively, the operation identifier queue 208 may maintain a list of operation identifiers that are free and/or candidates for reassignment. For example, all free operation identifiers may be assigned before the operation identifier allocator 204 performs a reassignment.

FIG. 4 is a flow diagram 400 representative of example machine readable instructions that may be executed to identify an operation identifier(s) that is a candidate for reassignment. The process 400 of FIG. 4 begins when the example operation identifier usage analyzer 212 determines if it is time for candidate identification (e.g., identification of an operation identifier(s) that is a candidate for reassignment) to be performed (block 402). For example, candidate identification may be performed on a periodic time schedule, on an aperiodic time schedule, after a threshold number of operations have been scheduled, in response to a request for a new operation identifier, etc. When the operation identifier usage analyzer 212 determines that it is not time for a candidate identification, the operation identifier usage analyzer 212 continues to wait until it is time for a candidate identification.

When the operation identifier usage analyzer 212 determines that a candidate identification is to be performed (block 402), the example operation identifier usage analyzer 212 identifies an operation identifier that meets a candidate identification rule (block 404). For example, the example operation identifier usage analyzer 212 of FIG. 2 determines a candidate as the least recently used operation identifier (e.g., the operation identifier with the oldest last usage timestamp). The operation identifier usage analyzer 212 may identify the least recently used operation identifier by sorting the operation identifiers in the example operation identifier timing datastore by last usage timestamp, but iterating through the operation identifiers in the operation identifier timing datastore, etc. Alternatively, any other method for identifying a candidate operation identifier(s) may be utilized (e.g., identifying one or more candidate identifiers that have least frequently been used, identifying all operation identifiers in a list that is ordered by frequency of usage and/or last use timestamp, etc.).

Once the operation identifier usage analyzer 212 has identified a candidate operation identifier(s) in the example operation identifier timing datastore, the example operation identifier usage analyzer 212 stores the candidate operation identifier(s) in the example operation identifier queue 208 (block 406). Control then returns to block 402 to await the next time for candidate identification.

According to the illustrated example, the candidate identification process 400 of FIG. 4 runs outside the operation flow of the operation identifier assignment illustrated in FIG. 3. Accordingly, the overhead associated with candidate identification does not impact the task scheduling of FIG. 3. In some examples, the process 400 operates on a different processor and/or a different core than the process of FIG. 3.

Alternatively, the candidate identification of FIG. 4 may be performed within the process 300 of FIG. 3 (e.g., in response to a request for a new operation identifier assignment).

FIG. 5 is a block diagram of an example processor platform 500 capable of executing the instructions of FIG. 3 and/or FIG. 4 to implement the example virtual operation identifier manager 106 of FIG. 1 and/or FIG. 2. The processor platform 500 can be, for example, a server, a personal computer, a mobile device (e.g., a cell phone, a smart phone, a tablet such as an iPad™), or any other type of computing device.

The processor platform 500 of the illustrated example includes a processor 512. The processor 512 of the illustrated example is hardware. For example, the processor 512 can be implemented by one or more integrated circuits, logic circuits, microprocessors or controllers from any desired family or manufacturer.

The processor 512 of the illustrated example includes a local memory 513 (e.g., a cache). The example processor 512 includes the example task scheduler 202, the example operation identifier allocator 204, the example operation identifier activity recorder 210, and the example operation identifier usage analyzer 212. The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, one or more input devices 522 are connected to the interface circuit 520. The input device(s) 522 permit(s) a user to enter data and commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 520 of the illustrated example, thus, typically includes a graphics driver card, a graphics driver chip or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes one or more mass storage devices 528 for storing software and/or data. Examples of such mass storage devices 528 include floppy disk drives, hard drive disks, compact disk drives, Blu-ray disk drives, RAID systems, and digital versatile disk (DVD) drives. The example mass storage devices 528 store the example operation identifier timing datastore 206 and the example operation identifier queue 208.

The coded instructions 532 of FIG. 5 may be stored in the mass storage device 528, in the volatile memory 514, in the non-volatile memory 516, and/or on a removable tangible computer readable storage medium such as a CD or DVD.

From the foregoing, it will be appreciated that methods, apparatus and articles of manufacture have been disclosed which facilitate the assignment of operation identifiers to operations even when the number of operation identifiers supported by a processor(s) have been utilized. Accordingly, some examples reduce hardware utilization and resource utilization overhead by reducing the number of operation identifiers that must be supported by a processor(s) to handle resource allocation for a large number of threads that may be executed by the processor(s). By providing a virtual operation identifier manager, operation identifiers are re-used and re-assigned to operations even if an originally assigned operation has not been terminated. Such re-assignment reduces the need to expend processor resources handling larger operation identifiers and/or reduces the need to redesign a processor(s) to support larger operation identifiers.

Example methods, apparatus, systems and articles of manufacture to offload computations in a computer networked environment are disclosed herein. Further examples and combinations thereof include the following.

Example 1 is an example apparatus for scheduling operations for resource sharing on computing systems that includes: an operation identifier usage analyzer to determine that an operation identifier is inactive, the operation identifier assigned to a first operation, an operation identifier allocator to free the operation identifier from the first operation and assign the operation identifier to a second operation, and at least one processor to utilize the operation identifier to allocate computing resources of the apparatus to a second operation.

Example 2 includes the apparatus as defined in example 1, wherein the first operation is associated with a process that is active.

Example 3 includes the apparatus as defined in one of example 1 or example 2, wherein the at least one processor is to recognize a set of operation identifiers and all of the operation identifiers in the set of operation identifiers are assigned to operations at a time when the operation identifier usage analyzer determines that that the operation identifier is inactive.

Example 4 includes the apparatus as defined in example 1, further including an operation identifier activity recorder to update a timestamp when an operation associated with the operation identifier is executed.

Example 5 includes the apparatus as defined in example 4, wherein the operation identifier usage analyzer is to determine that the operation identifier is inactive by determining that the timestamp is older than timestamps associated with other operation identifiers.

Example 6 includes the apparatus as defined in example 5, wherein the operation identifier allocator is to determine if a difference between a current time and the timestamp meets a threshold.

Example 7 includes the apparatus as defined in one of example 1 or example 2, further including an operation identifier activity recorder to update a frequency count when an operation associated with the operation identifier is executed.

Example 8 includes the apparatus as defined in example 7, wherein the operation identifier usage analyzer is to determine that the operation identifier is inactive by determining that the frequency count is less than frequency counts associated with other operation identifiers.

Example 9 includes the apparatus as defined in example 1, further including a datastore of operation identifiers supported by the processor and timestamps associated with the operation identifiers, the timestamps indicating a time when an operation assigned to the operation identifier was last scheduled for execution.

Example 10 includes the apparatus as defined in example 1, wherein the first operation is at least one of a task or a task group.

Example 11 includes the apparatus as defined in example 1, wherein the operation identifier is a class of service identifier.

Example 12 is a method for scheduling operations for resource sharing on computing systems that includes: determining, by executing an instruction with a processor, that an operation identifier is inactive, the operation identifier assigned to a first operation, the operation identifier utilized by the processor to allocate computing resources of a computing system to the first operation, and in response to a request for assignment of an operation identifier to a second operation: freeing, by executing an instruction with the processor, the operation identifier from the first operation, and assigning, by executing an instruction with the processor, the operation identifier to the second operation.

Example 13 includes the method as defined in example 12, wherein the first operation is associated with a process that is active.

Example 14 includes the method as defined in one of example 12 or example 13, wherein the processor is capable of recognizing a set of operation identifiers and all of the operation identifiers in the set of operation identifiers are assigned to operations at a time of the determining.

Example 15 includes the method as defined in example 12, further including updating a timestamp when the second operation is executed.

Example 16 includes the method as defined in one of example 12 or example 13, wherein determining that the operation identifier is inactive includes determining that a timestamp is older than timestamps associated with other operation identifiers.

Example 17 includes the method as defined in example 16, further including determining if a difference between a current time and the timestamp meets a threshold.

Example 18 includes the method as defined in example 12, further including updating a frequency count when the operation identifier is utilized by the first operation.

Example 19 includes the method as defined in example 18, wherein determining that the operation identifier is inactive includes determining that the frequency count is less than frequency counts associated with other operation identifiers.

Example 20 includes the method as defined in example 12, further including maintaining a datastore of operation identifiers supported by the processor and timestamps for each operation identifier indicating a time when an operation assigned to the operation identifier was last scheduled for execution on the processor.

Example 21 includes the method as defined in example 12, wherein the first operation is at least one of a task or a task group.

Example 22 includes the method as defined in example 12, wherein the operation identifier is a class of service identifier.

Example 23 is a non-transitory machine readable storage medium comprising instructions that, when executed, cause a machine to at least: determine that an operation identifier is inactive, the operation identifier assigned to a first operation, the operation identifier utilized by a processor to allocate computing resources of a computing system to the first operation, and in response to a request for assignment of an operation identifier to a second operation: free the operation identifier from the first operation, and assign the operation identifier to the second operation.

Example 24 includes the non-transitory machine readable storage medium as defined in example 23, wherein the first operation is associated with a process that is active.

Example 25 includes the non-transitory machine readable storage medium as defined in one of example 23, or example 24 wherein the processor is capable of recognizing a set of operation identifiers and all of the operation identifiers in the set of operation identifiers are assigned to operations at a time of the determining.

Example 26 includes the non-transitory machine readable storage medium as defined in example 23, wherein the instructions, when executed, cause the machine to update a timestamp when the second operation is executed.

Example 27 includes the non-transitory machine readable storage medium as defined in example 23, wherein the instructions, when executed, cause the machine to determine that the operation identifier is inactive by determining that a timestamp is older than timestamps associated with other operation identifiers.

Example 28 includes the non-transitory machine readable storage medium as defined in example 27, wherein the instructions, when executed, cause the machine to determine if a difference between a current time and the timestamp meets a threshold.

Example 29 includes the non-transitory machine readable storage medium as defined in one of example 23 or example 24, wherein the instructions, when executed, cause the machine to update a frequency count when the operation identifier is utilized by the first operation.

Example 30 includes the non-transitory machine readable storage medium as defined in example 29, wherein the instructions, when executed, cause the machine to determine that the operation identifier is inactive by determining that the frequency count is less than frequency counts associated with other operation identifiers.

Example 31 includes the non-transitory machine readable storage medium as defined in example 23, wherein the instructions, when executed, cause the machine to maintain a datastore of operation identifiers supported by the processor and timestamps for each operation identifier indicating a time when an operation assigned to the operation identifier was last scheduled for execution on the processor.

Example 32 includes the non-transitory machine readable storage medium as defined in example 23, wherein the first operation is at least one of a task or a task group.

Example 33 includes the non-transitory machine readable storage medium as defined in example 23, wherein the operation identifier is a class of service identifier.

Example 34 is an apparatus for scheduling operations for resource sharing on computing systems that includes: means for determining that an operation identifier is inactive, the operation identifier assigned to a first operation, the operation identifier utilized by a processor to allocate computing resources of a computing system to the first operation, and means for, in response to a request for assignment of an operation identifier to a second operation: freeing the operation identifier from the first operation, and assigning the operation identifier to the second operation.

Example 35 includes the apparatus as defined in example 34, wherein the first operation is associated with a process that is active.

Example 36 includes the apparatus as defined in one of example 34 or example 35, wherein the processor is capable of recognizing a set of operation identifiers and all of the operation identifiers in the set of operation identifiers are assigned to operations at a time of the determining.

Example 37 includes the apparatus as defined in example 34, further including means for updating a timestamp when the second operation is executed.

Example 38 includes the apparatus as defined in example 34, wherein the means for determining that the operation identifier is inactive is to determine that a timestamp is older than timestamps associated with other operation identifiers.

Example 39 includes the apparatus as defined in example 38, further including means for determining if a difference between a current time and the timestamp meets a threshold.

Example 40 includes the apparatus as defined in one of example 34 or example 35, further including means for updating a frequency count when the operation identifier is utilized by the first operation.

Example 41 includes the apparatus as defined in example 40, wherein the means for determining that the operation identifier is inactive is to determine that the frequency count is less than frequency counts associated with other operation identifiers.

Example 42 includes the apparatus as defined in example 34, further including means for maintaining a datastore of operation identifiers supported by the processor and timestamps for each operation identifier indicating a time when an operation assigned to the operation identifier was last scheduled for execution on the processor.

Example 43 includes the apparatus as defined in example 34, wherein the first operation is at least one of a task or a task group.

Example 44 includes the apparatus as defined in example 34, wherein the operation identifier is a class of service identifier.

Example 45 is a system for scheduling operations for resource sharing on computing systems that includes: a virtual operation identifier manager to: determine that an operation identifier is inactive, the operation identifier assigned to a first operation, free the operation identifier from the first operation and assign the operation identifier to a second operation, and cache memory, at least one processor to: allocate a portion of the cache memory to the second operation based on the operation identifier, and execute the second operation.

Example 46 includes the system as defined in example 45, wherein the first operation is associated with a process that is active.

Example 47 includes the system as defined in one of example 45 or example 46, wherein the at least one processor is to recognize a set of operation identifiers and all of the operation identifiers in the set of operation identifiers are assigned to operations at a time when the virtual operation identifier manager determines that that the operation identifier is inactive.

Example 48 includes the system as defined in example 45, wherein the virtual operation identifier manager is to update a timestamp when an operation associated with the operation identifier is executed.

Example 49 includes the system as defined in example 48, wherein the virtual operation identifier manager is to determine that the operation identifier is inactive by determining that the timestamp is older than timestamps associated with other operation identifiers.

Example 50 includes the system as defined in example 49, wherein the virtual operation identifier manager is to determine if a difference between a current time and the timestamp meets a threshold.

Example 51 includes the system as defined in one of example 45 or example 46, wherein the virtual operation identifier manager is to update a frequency count when an operation associated with the operation identifier is executed.

Example 52 includes the system as defined in example 51, wherein the virtual operation identifier manager is to determine that the operation identifier is inactive by determining that the frequency count is less than frequency counts associated with other operation identifiers.

Example 53 includes the system as defined in example 45, further including a datastore of operation identifiers supported by the processor and timestamps associated with the operation identifiers, the timestamps indicating a time when an operation assigned to the operation identifier was last scheduled for execution.

Example 54 includes the system as defined in example 45, wherein the first operation is at least one of a task or a task group.

Example 55 includes the system as defined in example 45, wherein the operation identifier is a class of service identifier.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus for scheduling operations for resource sharing on computing systems, the apparatus comprising:
an operation identifier usage analyzer to determine that an operation identifier is inactive, the operation identifier assigned to a first operation;
an operation identifier allocator to free the operation identifier from the first operation and assign the operation identifier to a second operation; and
at least one processor to utilize the operation identifier to allocate computing resources of the apparatus to a second operation.

2. An apparatus as defined in claim 1, wherein the first operation is associated with a process that is active.

3. An apparatus as defined in claim 1, wherein the at least one processor is to recognize a set of operation identifiers and all of the operation identifiers in the set of operation identifiers are assigned to operations at a time when the operation identifier usage analyzer determines that that the operation identifier is inactive.

4. An apparatus as defined in claim 1, further including an operation identifier activity recorder to update a timestamp when an operation associated with the operation identifier is executed.

5. An apparatus as defined in claim 4, wherein the operation identifier usage analyzer is to determine that the operation identifier is inactive by determining that the timestamp is older than timestamps associated with other operation identifiers.

6. An apparatus as defined in claim 5, wherein the operation identifier allocator is to determine if a difference between a current time and the timestamp meets a threshold.

7. An apparatus as defined in claim 1, further including an operation identifier activity recorder to update a frequency count when an operation associated with the operation identifier is executed.

8. An apparatus as defined in claim 7, wherein the operation identifier usage analyzer is to determine that the operation identifier is inactive by determining that the frequency count is less than frequency counts associated with other operation identifiers.

9. An apparatus as defined in claim 1, further including a datastore of operation identifiers supported by the processor and timestamps associated with the operation identifiers, the timestamps indicating a time when an operation assigned to the operation identifier was last scheduled for execution.

10. An apparatus as defined in claim 1, wherein the first operation is at least one of a task or a task group.

11. An apparatus as defined in claim 1, wherein the operation identifier is a class of service identifier.

12. A method for scheduling operations for resource sharing on computing systems, the method comprising:
determining, by executing an instruction with a processor, that an operation identifier is inactive, the operation identifier assigned to a first operation, the operation identifier utilized by the processor to allocate computing resources of a computing system to the first operation; and
in response to a request for assignment of an operation identifier to a second operation:
freeing, by executing an instruction with the processor, the operation identifier from the first operation; and
assigning, by executing an instruction with the processor, the operation identifier to the second operation.

13. A method as defined in claim 12, wherein the first operation is associated with a process that is active.

14. A method as defined in claim 12, wherein the processor is capable of recognizing a set of operation identifiers and all of the operation identifiers in the set of operation identifiers are assigned to operations at a time of the determining.

15. A method as defined in claim 12, further including updating a timestamp when the second operation is executed.

16. A method as defined in claim 12, wherein determining that the operation identifier is inactive includes determining that a timestamp is older than timestamps associated with other operation identifiers.

17. A method as defined in claim 16, further including determining if a difference between a current time and the timestamp meets a threshold.

18. A method as defined in claim 12, further including updating a frequency count when the operation identifier is utilized by the first operation.

19. A method as defined in claim 18, wherein determining that the operation identifier is inactive includes determining that the frequency count is less than frequency counts associated with other operation identifiers.

20. A method as defined in claim 12, further including maintaining a datastore of operation identifiers supported by the processor and timestamps for each operation identifier indicating a time when an operation assigned to the operation identifier was last scheduled for execution on the processor.

21. A method as defined in claim 12, wherein the first operation is at least one of a task or a task group.

22. A method as defined in claim 12, wherein the operation identifier is a class of service identifier.

23. A non-transitory machine readable storage medium comprising instructions that, when executed, cause a machine to at least:
determine that an operation identifier is inactive, the operation identifier assigned to a first operation, the operation identifier utilized by a processor to allocate computing resources of a computing system to the first operation; and
in response to a request for assignment of an operation identifier to a second operation:
free the operation identifier from the first operation; and
assign the operation identifier to the second operation.

24. A non-transitory machine readable storage medium as defined in claim 23, wherein the first operation is associated with a process that is active.

25. A non-transitory machine readable storage medium as defined in claim 23, wherein the processor is capable of recognizing a set of operation identifiers and all of the operation identifiers in the set of operation identifiers are assigned to operations at a time of the determining.
